(19) United States
(12) Patent Application Publication
(10) Pub. No.: US 2005/0165634 A1
(43) Pub. Date: Jul. 28, 2005

(54) Internet-based compensation survey

(76) Inventor: Tolo M. Rimsky, Lincolnshire, IL (US)

Correspondence Address: FOLEY & LARDNER, 321 NORTH CLARK STREET, SUITE 2800, CHICAGO, IL, 60610-4764, US

(21) Appl. No.: 10/765,537

(22) Filed: Jan. 27, 2004

(51) Int. Cl. G06F 17/60

(52) U.S. Cl. 705/10

(57) ABSTRACT

The present invention relates to an internet-based compensation survey. Initially, a market is selected against which to be compared and a job is selected to be researched. The system provides and displays market data for the job selected. In preferred embodiments, the system allows users to perform interpolation or extrapolation based on employment categories, enables the user to project to a future date, provides recommendations about merit increases; and enables the user to view market data graphically.

### COPYRIGHT NOTICE

A portion of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to Internet enabled compensation survey systems.

### BACKGROUND OF THE INVENTION

The Internet is a global network of computers. Network servers support hypertext capabilities that permit the Internet to link together webs of documents. User interfaces such as Graphical User Interfaces (GUI) are typically used to navigate the Internet to retrieve relevant documents. Uniform Resource Locators (URLs) are used to identify specific web sites and web pages on the Internet. URLs also identify the address of the document to be retrieved from a network server. The Transfer Control Protocol/Internet Protocol (TCP/IP) is used to transfer information.

The Internet uses a hypertext language referred to as the hypertext mark-up language (HTML). HTML is a commonly used scripting or programming language that permits content providers or developers to place hyperlinks within web pages. These hyperlinks link related content or data, which may be found on multiple Internet host computers. HTML document links may retrieve remote data by use of Hyertext Transfer Protocol (HTTP). Alternatively, File Transfer Protocol (FTP), Gopher, or other Internet application protocols can be used. When a user clicks on a link in a web document, the link icon in the document contains the URL that the client employs to initiate the session with the server storing the linked document. HTTP is the protocol used to support the information transfer.

While most of today's users of the Internet believe it is a recent communications phenomenon, the origins of the Internet actually go back several decades. Today's Internet grew out a computer resource-sharing network created in the 1960s by the Advanced Research Projects Agency (ARPA). This computer resource-sharing network, which came to be known as the ARPAnet, was primarily designed by ARPA's chief scientist, Larry Roberts. The initial problem facing a wide-area computer resource-sharing network was how to efficiently transmit digitized information in a reliable way. To solve this problem, in 1968, Roberts mandated use of a packet-switching design in the ARPAnet.

Packet switching breaks up blocks of digitized information into smaller pieces called packets. These packets are transmitted through the network, usually by different routes, and are then reassembled at their destination. Eight years prior to ARPA's RFP, Len Kleinrock invented packet switching. See, e.g., Len Kleinrock, “Information Flow in Large Communications Nets,” RLE Quarterly Progress Report (1960); Len Kleinrock, Communication Nets (1964). See also Paul Baren, “On Distributed Communications Networks,” IEEE Transactions on Systems (March 1964). Roberts believed that packet switching was the means to efficiently transmit digitized information in a reliable way.

The next problem to solve was how to interconnect a number of mainframe computers, most of which utilized different languages and different operating systems. Wesley Clark of Washington University in St. Louis, Mo., devised the solution to this huge incompatibility problem. Clark proposed that a smaller microcomputer should interface between every mainframe and the network. All of these minicomputers would run on the same operating system and use the same language. Each mainframe, therefore, would only be required to interface with its own minicomputer, with the minicomputer translating into the network operating system and language. These Interface Message Processors (IMP), which provided an interface between the ARPAnet host mainframe computers and the ARPAnet, were the predecessors to today's routers. With this basic design, the first two nodes on the ARPAnet communicated on 1 Oct. 1969.

By 1971, 15 nodes, mostly academic institutions, were up on the ARPAnet. However, the original goal of the ARPAnet was not being realized. Resource sharing of the mainframe computers was simply too cumbersome. In March 1972, however, Ray Tomlinson of Bolt, Beranek & Newman invented e-mail. Use of this message transfer program quickly grew to be the initial major use of the ARPAnet.

By the mid-seventies, the ARPAnet was not the only network utilizing switching packets. Once again, an incompatibility problem emerged. Each of these different networks used a different protocol. Thus, interconnection of these different networks was not possible. The solution, devised by Robert Kahn of ARPA and Vincent Cerf of Stanford University, was called the Transmission Control Protocol/Internet Protocol. The Transmission Control Protocol packetized information and reassembled the information upon arrival. The Internet Protocol routed packets by encasing the packets between networks. See, e.g., Robert Kahn and Vincent Cerf, “A Protocol for Packet Network Intercommunication,” IEEE Transactions on Communications Technology (May 1974). Transmission Control Protocol/Internet Protocol was adopted by the ARPAnet in 1983. With the addition of the Domain Name System (DNS) in November 1983, the now familiar Internet address protocol was established.

A final step in creating the Internet occurred in 1990, when an Englishman, Tim Berners-Lee of the European Center for Particle Research (CERN) in Switzerland, invented the World Wide Web. This software, based on a program Berners-Lee had written in 1980 to allow users to store information using random associations, allowed material from any computer, from any format to be translated into a common language of words, images, and addresses. Berners-Lee's program established the three core components of the World Wide Web: the Universal Resource Locator, Hypertext Transfer Protocol, and HyperText Markup language.

The initial focus of e-commerce technologies on the Internet was to facilitate business-to-consumer (B2C) transactions. This lead to a frenzy of investment into nearly any Internet related B2C idea, even where the idea lacked real merit. This investment frenzy came to an abrupt end when the Internet valuation bubble burst in March 2000: from its March 2000 high of 5,047.69, the technology rich NASDAQ stock index fell over 40%.

Increasingly, however, businesses are finding economies in transacting business-to-business (B2B) over the Internet. Thus far, however, such B2B transactions over the Internet have proven largely unsatisfactory for increasing productivity in the dissemination of information to human resource, compensation, and benefit managers, and the like.

Thus, what is needed is an automated system of dissemination of information to human resource, compensation, and benefit managers, and the like. Such a system would allow for the user to analyze human resource information quickly and efficiently in a dynamically changing environment.

### SUMMARY OF THE INVENTION

An automated system in accordance with the principles of the present invention effectively disseminates information to human resource, compensation, and benefit managers, and the like. An automated system in accordance with the principles of the present invention allows for the user to analyze human resource information quickly and efficiently in a dynamically changing environment.

In an automated system in accordance with the principles of the present invention a market is selected against which to be compared and a job is selected to be researched. The system provides and displays market data for the job selected. In preferred embodiments, the system allows users to perform interpolation or extrapolation based on employment categories, enables the user to project to a future date, provides recommendations about merit increases, and enables the user to view market data graphically.

### DESCRIPTION OF THE FIGURES

FIG. 1 is a home page graphical user interface of a business-to-business compensation survey system in accordance with the principles of the present invention.

FIG. 2 is an options page of the business-to-business compensation survey system of FIG. 1.

FIG. 3 is an Interpolation/Extrapolation option page of the business-to-business compensation survey system of FIG. 1.

FIG. 4 is an example pop-up screen of the Interpolation/Extrapolation option page of FIG. 3 showing job code 1 as a human resource administrator.

FIG. 5 is an example screen of the Interpolation/Extrapolation option page of FIG. 3 showing an Industry Results for job code 1—human resource administrator in the category all companies.

FIG. 6 is a Projection option page of the business-to-business compensation survey system of FIG. 1.

FIG. 7 is a Merit Matrix option page of the business-to-business compensation survey system of FIG. 1.

FIG. 8 is a Graphical Analysis option page of the business-to-business compensation survey system of FIG. 1.

FIG. 9 is an example screen of the Graphical Analysis option page of FIG. 8 showing an Actual Bonuses Paid and Target Bonuses graph in the Benefits Analysis section.

FIG. 10 is an example screen of the Graphical Analysis option page of FIG. 8 showing a Company Monthly Salary graph for the for job code 1—human resource administrator in the category all companies.

FIG. 11 is an example screen of the Graphical Analysis option page of FIG. 8 showing a Company Data compared with the market Average and Quartiles graph for the for job code 1—human resource administrator in the category all companies.

FIG. 12 is an example screen of the Graphical Analysis option page of FIG. 8 showing a Company Versus Market (Graphical) graph for the for job code 1—human resource administrator in the category all companies.

FIG. 13 is an example screen of the Graphical Analysis option page of FIG. 8 showing a Company Versus Market (Tabular) graph for the for job code 1—human resource administrator in the category all companies.

### DETAILED DESCRIPTION OF THE PREFERRED EMBODIMENTS

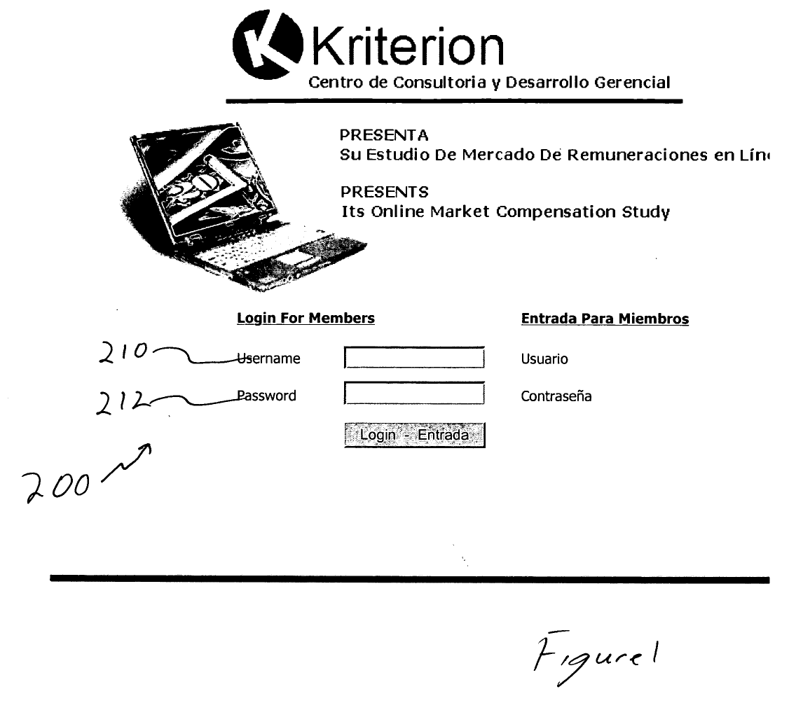

Referring to FIG. 1, a home page graphical user interface (GUI) 200 of a business-to-business compensation survey system in accordance with the principles of the present invention is seen. To enter the system the user must enter the web-site. Once the system opens it will ask for the Username 210 and the Password 212. A name and password are provided to each participant to enter the system for the first time and they can continue using them, if they so wish, but they can change these at will for their exclusive use.

In one embodiment, the system can be composed of three major elements: the Web Browser 210, the Web Server 220, and the Database Server 230. The Web Browser 210 is platform (e.g. Sparc™, Risc, x86) independent and operates on any software capable of displaying HTML files such as Internet Explorer from Microsoft Corporation of Redmond, Wash. or Netscape Communicator from Netscape Communications Corporation of Mountain View, Calif. The Web Server 220 may be hosted on a network of server engines 222. These server engines can be Intel-based server systems available from Intel Corporation of Santa Clara, Calif. running on a Microsoft Windows NT Server operating system available from Microsoft Corporation using Enterprise Webserver software from Netscape Communications Corporation. Each of these components may be hosted on separate machines, each of which may be a component of a server farm. Alternative computer systems consisting of one or more computers employing different forms of operating systems and application systems may be used to host the system of the present invention.

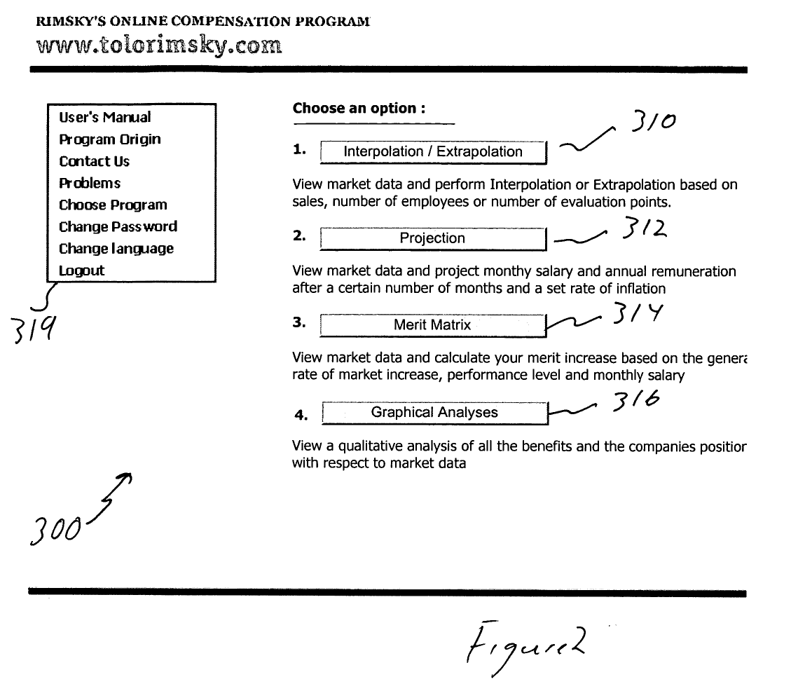

In one embodiment, after entering the system, the user will find a page that asks which is the preferred language. In a preferred embodiment, the choices can be Spanish or English. Next an options page 300 is opened that asks for an option to be selected. The options page is seen in FIG. 2. In a preferred embodiment, the options include Interpolation/Extrapolation 310, Projection 312, Merit Matrix 314, and Graphical Analyses 316. On the left side of the option page there is a table 319 providing additional resources. In a preferred embodiment, the additional resources include User's Manual; Program Origin; Contact us; Problems—procedures to follow, Choose Program—the same options that appear at the right; Change Password; Change Language—to switch from one language to the other; and Logout. The options provided on the options page 300 provide market data for the job selected, but each offers an additional feature, as explained below.

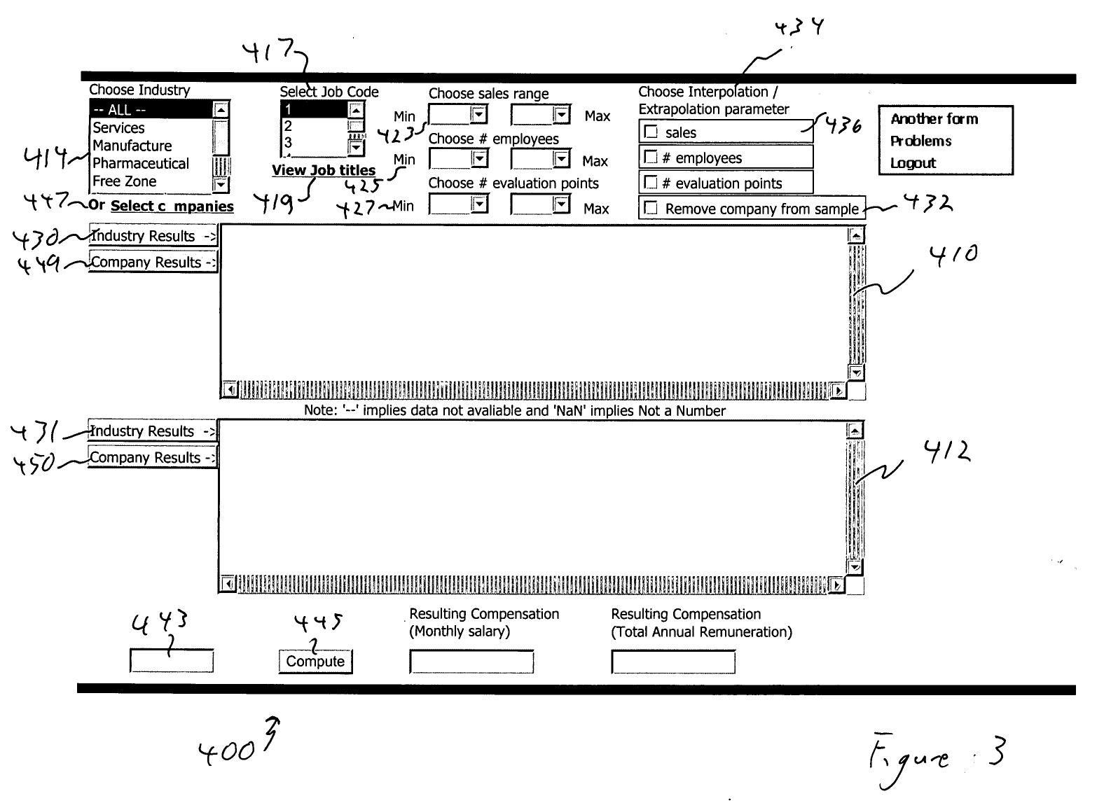

In a preferred embodiment, the first option is the Interpolation/Extrapolation option. The Interpolation/Extrapolation option allows the user to view market data and perform Interpolation or Extrapolation based on sales, number of employees, or number of evaluation points. Referring to FIG. 3, the Interpolation/Extrapolation option page 400 is seen.

When an option is selected the screen will show two rectangles 410, 412, where the data for the required position will appear. Before selecting a job, the user must select the industry to which he/she wishes the company to be compared. The different industries appear in the upper left part of the screen 414. In a preferred embodiment, the industries can include services, manufacturing, pharmaceutical, free zone, commercial (not shown), insurance (not shown), banking (not shown), and other industries as may appear, as well as classification of industries by geographical locations, and combinations thereof. If preferred, the comparison can be with all participants at once.

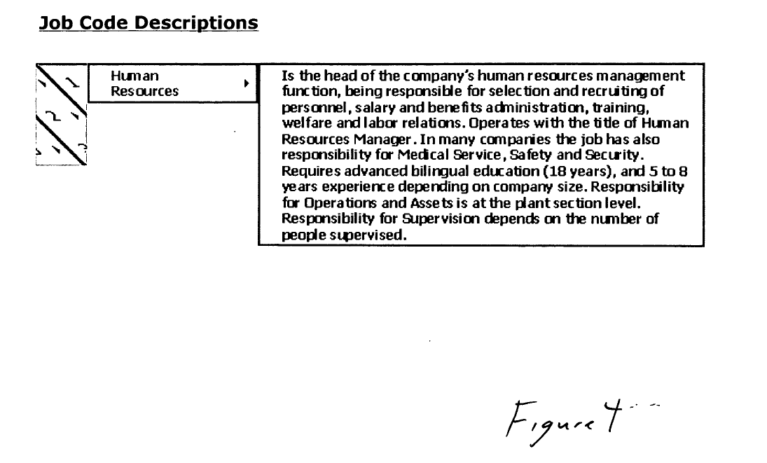

The next selection is the job to be researched. The jobs are codified 417, but immediately below the job codes the user can find the titles of the jobs surveyed 419. The descriptions of the jobs pop-up when the cursor is moved next to the job code and then moved to the job title. For example, referring to FIG. 4, a pop-up screen showing the job code 1 as a human resource administrator, including a job description, is seen.

Referring back to FIG. 3, the user can select the market to be compared. In the preferred embodiment, the market to be compared can also be selected by Sales Range 423, by Number of Employees 425, or by Evaluation Points 427. The user selects a minimum and a maximum number of sales, employees, and/or evaluation points, and the comparison is limited to the companies that are within those parameters.

The selection of market to be compared does not have to be limited to one of the parameters. The system of the present invention combines selections and makes comparisons to companies within those parameters, such as manufacturing companies with sales between X and Y; provided, however, that the more parameters are selected the more the data is diluted.

Each of the surveyed jobs is evaluated as per a number of factors. In a preferred embodiment, these factors include education, experience, responsibility for operations, responsibility for company assets, responsibility for supervision, and working conditions including hazards. The users can be informed of the point values assigned to their jobs via e-mail by request.

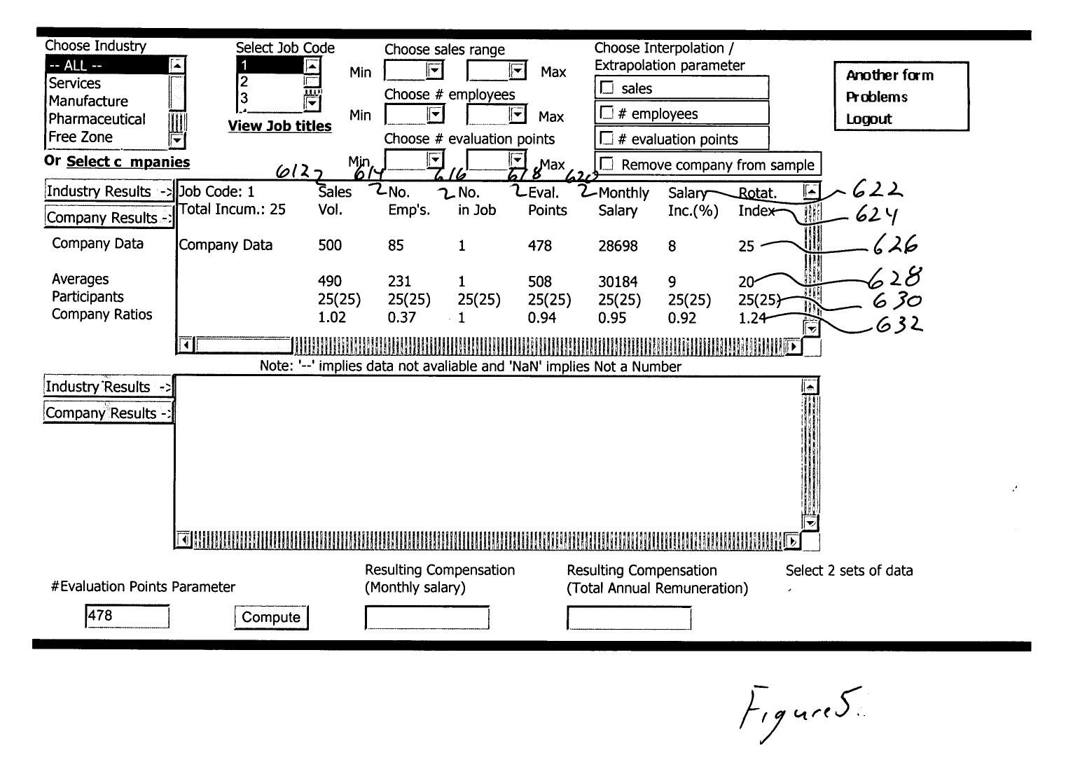

When the market to be compared has been selected, the user clicks on the box Industry Results 430. Upon doing this, the code of the job being researched will appear as will the total number of incumbents in the job for which data was gathered. For example, FIG. 5 shows this information for job code 1—human resource administrator in the category all companies. The total number of incumbents in the job may be higher than the number of participating companies because there are many jobs that have more than one participant. Opposite this number there is a line showing the values being presented.

In a preferred embodiment, these values include Annual Sales Volume 612, Number of Employees in the Company 614, Number of People in the Job 616, Evaluation Points 618, Monthly Salary 620, Percentage of Salary Increase Granted 622, Rotation Index 624, Validity of the Data in Months (counted from last increase) (not shown), Profit Sharing (not shown), Days of Christmas Pay (not shown), Christmas Pay in Money (not shown), Vacation Days (not shown), Vacation Bonus Days (not shown), Vacation Bonus in Money (not shown), Performance Bonus (not shown), Variable Pay in Months (not shown), Variable Pay in Money (not shown), Target Variable Pay in Months (not shown), Target Variable Pay in Money (not shown), Incentives and Commissions (not shown), Stock Sale in Months (not shown), Stock Sale in Money (not shown), Stock Cession in Month (not shown), Stock Cession in Money (not shown), Stock Options in Months (not shown), Stock Options in Money (not shown), Other Cash Income (not shown), Value of Company Car Benefit (not shown), Vehicle Expenses (not shown), Transportation Allowance (not shown), Percentage of Food Allowance (not shown), Food Allowance in Money (not shown), Value of Medical Insurance (not shown), Value of Dental Insurance (not shown), Value of Life Insurance (not shown), Percentage of Contribution to Pension (not shown), Annual Value of Pension (not shown), Cellular Bonus (not shown), Percentage of Saving Fund (not shown), Saving Fund in Money (not shown), Annual Value of Loans (not shown), Company Products (not shown), Educational Bonus (not shown), Annual Value of Medical Check-Up (not shown), Use of Company Credit Card (not shown), Annual Value of Clubs (not shown), Annual Cash Remuneration (not shown), Total Non Taxable Remuneration (not shown), Grossed-Up Non Taxable Remuneration (not shown), and Total Annual Remuneration (not shown).

For each job the system will preferably display four lines. The first line contains the Data of the Company 626 that is using the system. These data appears automatically the moment the user enters his/her name and password. Nobody else has access to this information. The second line shows the Market Averages 628 for each of the elements mentioned above. The third line is the Number of Participants 630 that provided data for the particular element, with the Number of Incumbents affected by that element in parenthesis. The fourth line is the Proportion of Company Ratios with respect to the Market Averages 632. When a company does not report certain elements and these do not exist in the market, the proportion appears as NaN, indicating that a proportion cannot be established. When data is not available, the designation “--” appears.

In accordance with a preferred embodiment of the present invention, the reported values of the company are secured through a personal interview with a responsible company representative to ensure the proper matching of jobs. The title with which the company identifies the job is not determinative of the category into which the position will be classified: rather, the job is classified with jobs of similar content. When more than one incumbent is in a job the information requested is the average of all incumbents or a representative figure of the group. Each company receives a diskette that contains its information, which can be easily updated in the future. In a preferred embodiment, the updating of the information is made at least once a month.

The number of months that the data is valid is measured from the time the employee received the last salary increase. This is the most effective way of establishing how long the data has existed in the market. As for the target bonuses, in one embodiment companies can specify the number of months of salary an employee can receive in the way of bonus. In the Analysis of Benefits which is discussed below, a relationship between the actual bonus received and the target bonus is seen.

In accordance with a preferred embodiment of the present invention, the benefits are valued according to what the benefits would cost the employee to secure on his/her own, not on what the company pays for them. This pricing is done on the basis of market studies made among insurance companies, automobile vendors, clubs and typical restaurants where employees could obtain their food.

In a preferred embodiment, if the user desires the values of his/her company can be removed from the market averages. To remove the company values, the user clicks on the square that says “Remove Company from Sample” 432 and clicks again the line that reads Industry 430. A new set of figures will appear, which will not include the company data.

The lower rectangle 412 can be used to display a new set of data. This new set of data allows a comparison between both sets of data. This new set of data allows also for interpolation or extrapolation of the information.

For example, a user may select for the upper rectangle data on companies up to 200 million in sales and for the lower rectangle companies with over 200 million in sales. To effectuate this, the user clicks Industry 430, 431 in front of the rectangles 410, 412, each with the different employee ranges. If the user does not elect different parameters, the lower rectangle will show the same values as the upper rectangle.

When there are two different sets of data it is possible to interpolate or extrapolate information. For example, assume a user desires information for a sales volume of 550. If the average remuneration for an average sales volume of 450 is available, and the average remuneration for an average sales volume of 620 is also available, it is possible to interpolate information what should be the remuneration for a sales volume of 550. The information for a sales volume of 550 will be the result of the interpolation between both remuneration values. The system of the present invention does this automatically upon selection of the option Sales 436 in the rectangle that says Interpolation/Extrapolation 434 in the upper right part of the screen.

The interpolation/extrapolation can be by Sales 436, by Number of Employees 438 or by Evaluation Points 441. When selecting one of these options the company number will immediately appear in the lower left part of the screen. These numbers, however, can be changed at will. Then, upon pressing Compute 445, the interpolated numbers for Monthly Salary and Total Annual Remuneration will appear.

In accordance with the present invention, the interpolation or extrapolation is an approximation, but it is not based on solid principles of remuneration management. In addition, in markets there are frequent anomalies that can result in the interpolation and extrapolation feature not being possible. For example, a typical anomaly is when for a certain volume of sales there is a remuneration available, but for a higher volume of sales the market shows a lower remuneration. In these cases the system of the present invention will send a message saying that there is an anomaly.

If the user does not want to be compared with a certain industry in particular or with companies of a certain size regarding sales, number of employees, or evaluation points, the user can select a special group of companies with which to be compared. To implement this feature, the user clicks the line Select Companies 447 and the list of all participating companies appears. From that list the user selects the companies of interest. In order to preserve the confidentiality of any individual company, the user must select a minimum of five companies. If less than five companies are selected a message will appear reminding him/her that a minimum of five is required. Once the selection of companies is made, the use goes to the end of the list of companies, clicks the line that reads Submit List, and then the window closes.

After selecting the special universe of companies, the user clicks opposite any of the two rectangles the line that reads Companies 449, 450 instead of industries. The market data corresponding to the selected companies is shown, just as before the data for certain industry or for a certain range of sales, employee number, or evaluation points appears.

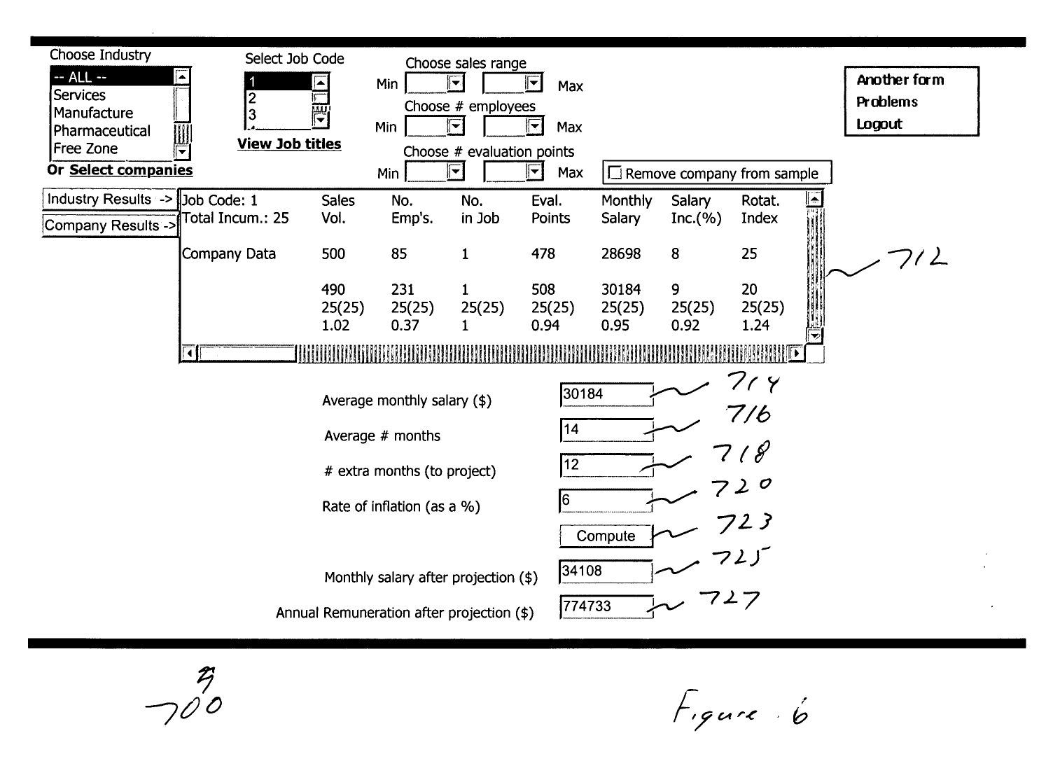

In the preferred embodiment, the second option is the Projection option. The Projection option enables the user to view market data and project monthly salary and annual remuneration after a certain number of months and a set rate of inflation. Referring to FIG. 6, the Projection option page 700 is seen. For ease of reference, a discussion of like elements from the Interpolation/Extrapolation option page 400 will not be repeated for each remaining figure.

As with the Interpolation/Extrapolation option, the Projection option shows the market values, but in addition it can project numbers to a future date. When selecting a group of companies to be compared, the data appears in a rectangle 712, just as the Interpolation/Extrapolation option. Immediately below the data rectangle, the average market value of monthly salary 714 and the number of months the data has been in existence in the market by the time it was processed 716 are seen (these are the same numbers that appear in the corresponding columns of the data rectangle).

Immediately below this information there is a space that asks how many more months the data is to be projected 718 and another space that asks for an estimate on the inflation for the period 720. Once this information is entered the reader clicks Compute 723 and the Monthly Salary 725 as well as the Annual Remuneration 727 projected to the desired date will appear.

For example, the Projection option page 700 of FIG. 6 shows this information for job code 1—human resource administrator in the category all companies, with the number of extra months set at 12 and the rate of inflation set at 6%.

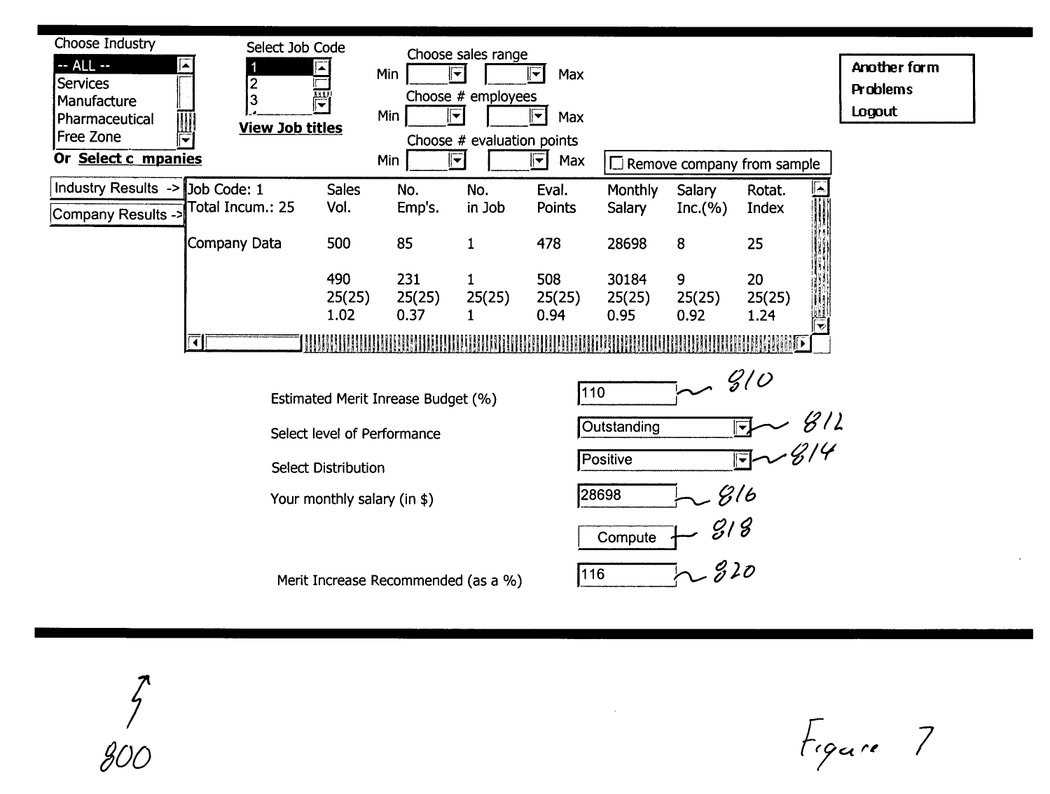

In the preferred embodiment, the third option is the merit matrix option. In addition to providing the market data, as the previous options do, the merit matrix option offers recommendations about merit increases. Referring to FIG. 7, the merit matrix option page 800 is seen.

The recommendations about merit increases are based on the relation of the salary of the incumbent in the position under study and the average market value. For this it is necessary that the user enter certain information. First, the user enters what the company believes will be its merit increase budget, expressed as a percentage of the total payroll 810. Next the user selects the level of performance of the incumbent 812. In a preferred embodiment, the level of performance can be selected from the group consisting of: Outstanding, Very Good, Satisfactory, Sometimes Acceptable and Poor. These options are contained in a drop-down menu.

The next selection is about the general distribution of salaries in the company 814. In a preferred embodiment, there are three options: Positive Distribution means that salaries tend to be in the upper part of the salary structures; Normal Distribution means that salaries are normally distributed around the midpoints of the structures; and Negative Distribution means that salaries tend to be in lower part of the structures. Again, these options are contained in a drop-down menu.

The monthly salary of the incumbent, the same that appears in the first line of the rectangle with data, appears repeated in the next line 816, but this number can be changed at will. Upon clicking Compute 818 the system of the present invention will provide a recommendation of what should be the percentage of merit increase 820, based on the established parameters. If some of the data is missing, a message will appear indicating what is missing.

In accordance with the principles of the present invention, the recommendation is based on a bi-dimensional matrix that contemplates performance and position within the salary range. When there are more that one incumbent in the job, the user may obtain different recommendations of salary increases, based on the performance of each incumbent.

For example, the merit matrix option page 800 of FIG. 7 shows this information for job code 1—human resource administrator in the category all companies, with the estimated merit increase set at 10%, the level of performance set at outstanding, and the distribution set at positive.

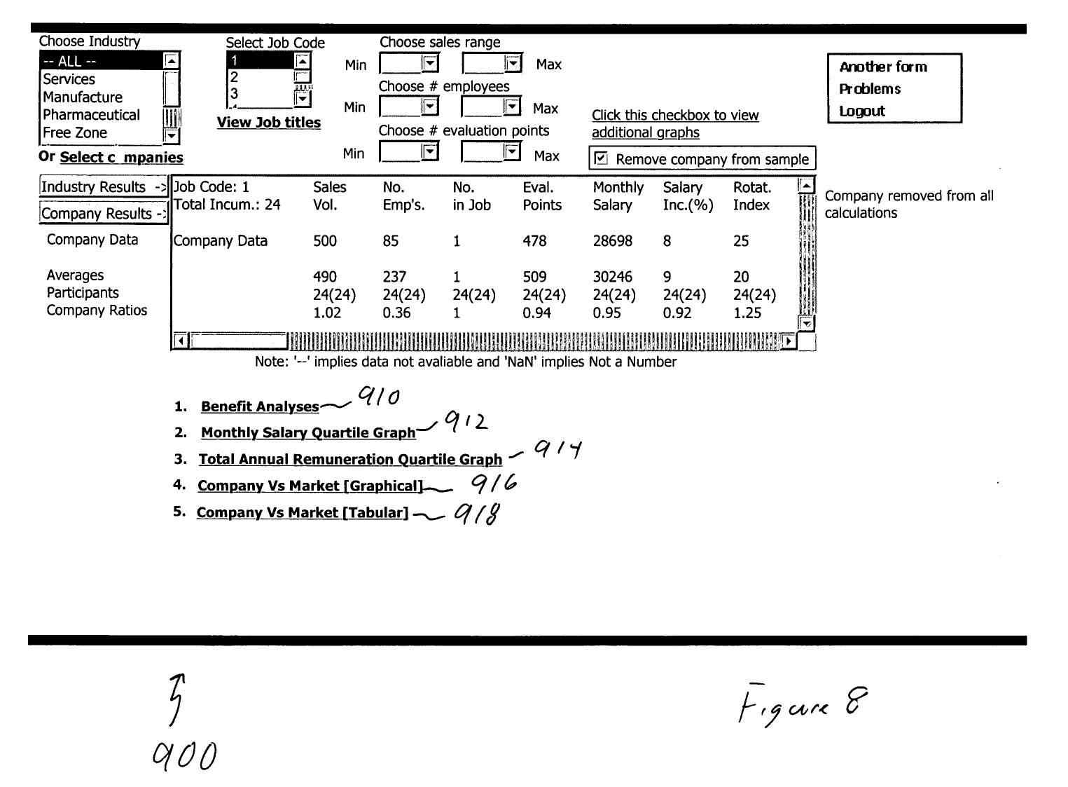

In the preferred embodiment, the fourth option is the graphical analysis option. The graphical analysis option enables the user to view market data and compare company verses market data. Referring to FIG. 8, the graphical analysis option page 900 is seen.

When selecting this option, the user will again select industries or companies to be compared. After making that selection, the corresponding data will appear on the screen, after clicking on Industry Results. In a preferred embodiment, three additional options are presented: Benefit Analyses 910, Monthly Salary Quartile Graphs 912, and Total Annual Remuneration Quartile Graphs 914. Then, after clicking again on Industry Results and if the company is removed from the sample, as discussed above, two more options appear: Company versus Market (Graphical) 916 and Company versus Market (Tabular) 918.

For example, the graphical analysis option page 900 of FIG. 8 shows this information for job code 1—human resource administrator in the category all companies, with the company removed from the sample.

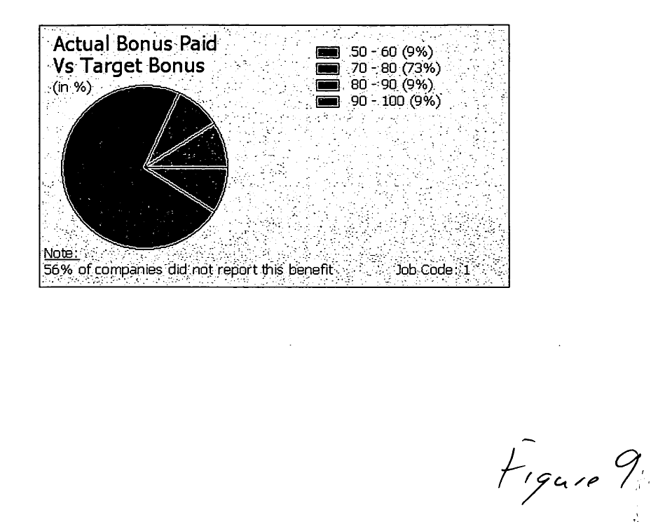

If the user selects the benefit analysis option a series of graphs that display the proportion of companies that provide the different benefits is provided. Each graph explains the terms on which the benefit is offered. For example, referring to FIG. 9, one of those graphs shows the relationship between Actual Bonuses Paid and Target Bonuses.

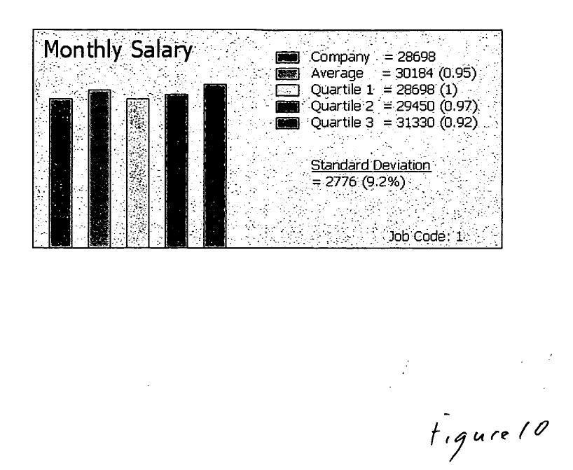

If the line Monthly Salary Quartile Graphs is clicked, several bar graphs will appear. The first bar graph corresponds to Company Monthly Salary for the job under analysis. An example of the Company Monthly Salary for the job under analysis is seen in FIG. 10. In a preferred embodiment, remaining bar graphs can include Market Average, First Quartile, Second Quartile, and Third Quartile. Also shown are the proportions of company values with respect to the market.

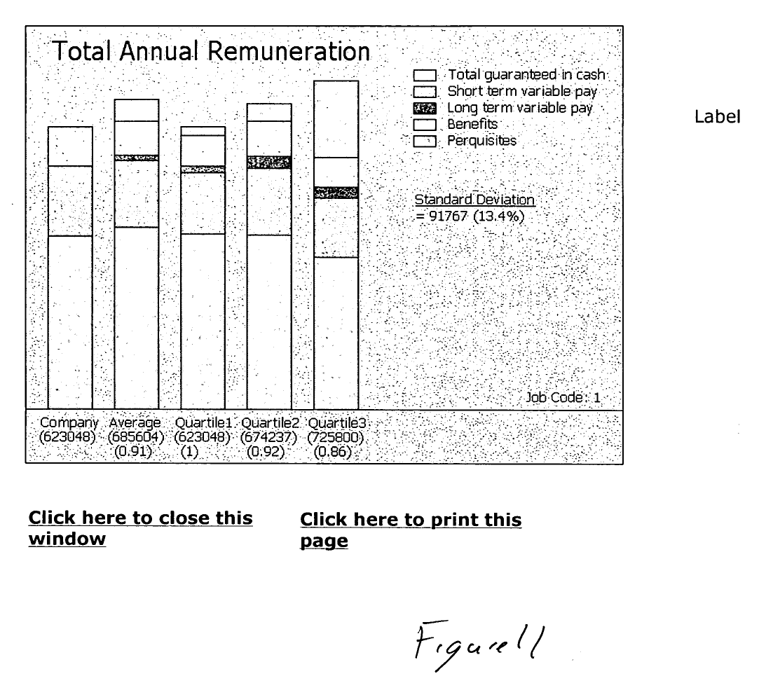

When clicking the Total Annual Remuneration Quartile Graphs, the bar graphs that appear are Company Data compared with the market Average and Quartiles. An example of the Company Data compared with the market Average and Quartiles for the job under analysis is seen in FIG. 11. In a preferred embodiment, the total remuneration bar graphs can be broken into Guaranteed Cash, Short Term Variable Pay, Long Term Variable Pay, Value of Benefits and Value of Prerequisites. The last two elements are in the grossed-up value from net of taxes.

The divisions of the different components of total annual remuneration are not intended to show the actual values of each of the components, but rather the proportion of each with respect to the total. Both Quartile Graphs also show the standard deviations of the sample, but these graphs, and consequently the standard deviations, change as the user selects a different set of companies to be compared.

In accordance with the principles of the present invention, the system can show a summary of the company's position with respect to the market, considering all the jobs for which the company has provided data. The company can thus obtain a quick overall picture of its standing with respect to the market. However, to make corrective decisions, if required, the company as to do it on a job by job basis.

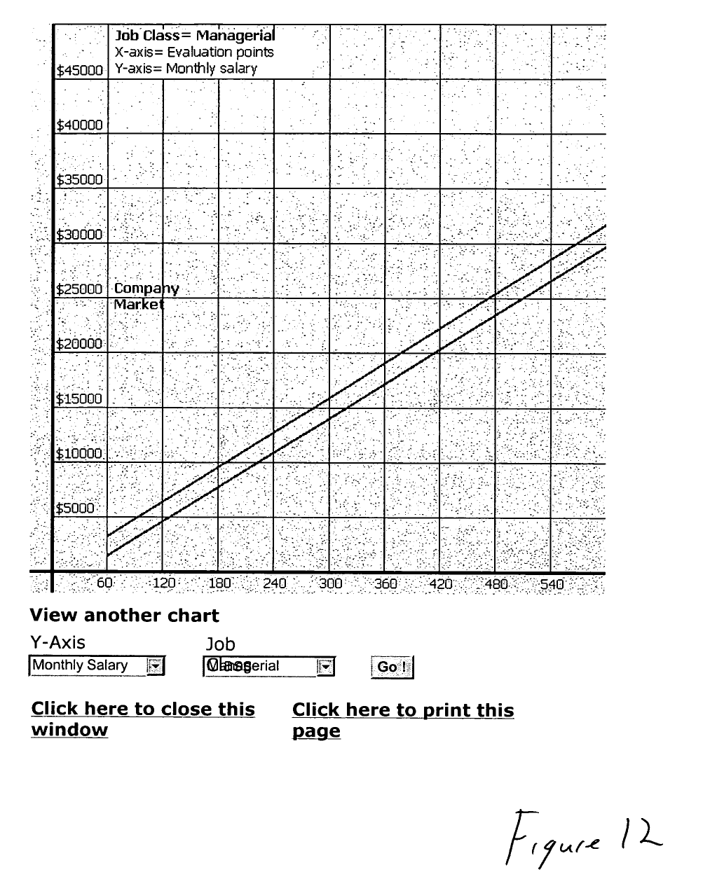

If the user presses on Company Versus Market (Graphical), two linear regression lines will appear, one for the Company and one for the Market. An example of the Company Versus Market (Graphical) is seen in FIG. 12. The reader has the possibility of shifting from Monthly Salary to Total Annual Remuneration, and also from Managerial Jobs to Administrative and Operation jobs. For this the reader selects Y Axis (Monthly Salary or Total Annual) and/or Job Class (Managerial, Administrative or Operation) and then press Go.

The graphs are calculated as linear regressions in which on the Y axis is the remuneration and the X axis are the evaluation points, both for the company and the market averages.

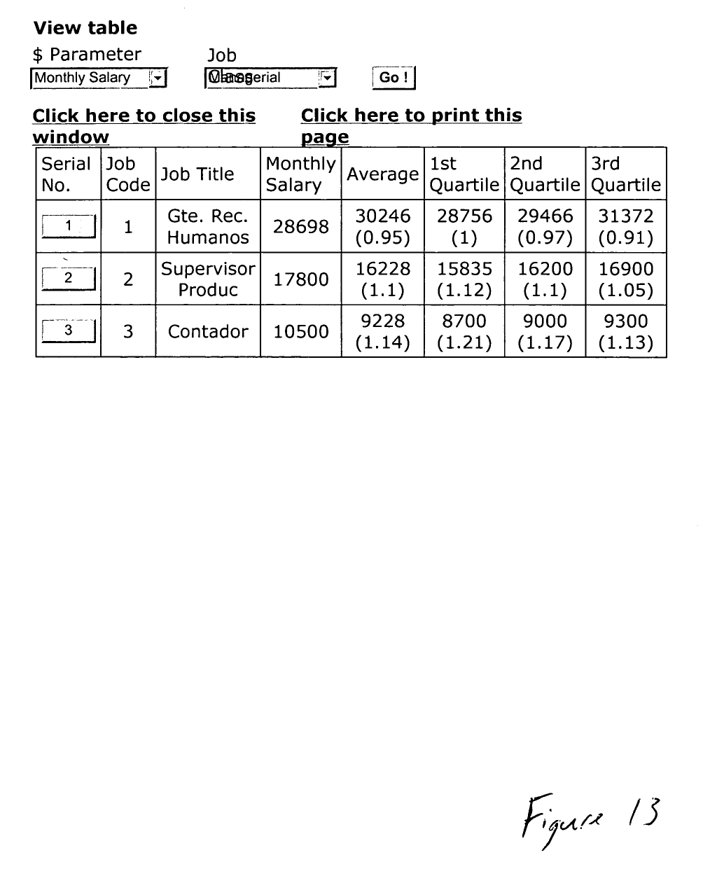

The Company Versus Market (Tabular) option presents the same information but the data of each position, both at the Company and the Market, appears in tables instead of graphs. An example of the Company Versus Market (Tabular) is seen in FIG. 13. Upon opening this option, the reader will see a Serial Number of Jobs, the Job Codes, and the Company Data. Upon pressing on the serial number the Market Data will appear. Again, in this case the reader can opt for Monthly Salary or Total Annual Pay, by pressing on the $ Parameter, and for Managerial, Administrative and Operation jobs by pressing on Job Class and then press Go.

While the invention has been described with specific embodiments, other alternatives, modifications and variations will be apparent to those skilled in the art. Accordingly, it is intended to include all such alternatives, modifications and variations set forth within the spirit and scope of the appended claims.

1. A computer networked compensation survey method comprising:
selecting a market against which to be compared;
selecting an employment category to be researched;
providing market data for the job selected;
displaying the market data;
allowing a user to perform interpolation or extrapolation based on at least one employment category;
enabling the user to project to a future date;
providing recommendations about merit increases; and
enabling the user to view market data graphically.

2. The computer networked compensation survey method of claim 1, wherein performing interpolation/extrapolation involves selecting from the group consisting of sales, number of employees, evaluation points, and combinations thereof.

3. The computer networked compensation survey method of claim 1 further comprising simultaneously displaying more than one set of data.

4. The computer networked compensation survey method of claim 1, wherein the market is selected from the group consisting of services, manufacturing, pharmaceutical, free zone, commercial, insurance, banking, and others that may appear, including classification of industries by geographical locations, and combinations thereof.

5. The computer networked compensation survey method of claim 1, wherein the market to be compared comprises a select group of companies with which to be compared.

6. The computer networked compensation survey method of claim 1, wherein the market to be compared is capable of being further narrowed to the group consisting of sales range, number of employees, evaluation points, and combinations thereof.

7. The computer networked compensation survey method of claim 1, wherein the market to be compared is capable of being further narrowed to evaluation points.

8. The computer networked compensation survey method of claim 7, further wherein the evaluation points are selected from the group consisting of education, experience, responsibility for operations, responsibility for company assets, responsibility for supervision, working conditions, and combinations thereof.

9. The computer networked compensation survey method of claim 1, wherein the employment category is selected from a minimum and a maximum number of sales and the comparison is limited to the companies that are within those parameters.

10. The computer networked compensation survey method of claim 1, wherein the employment category is selected from a minimum and a maximum number of employees and the comparison is limited to the companies that are within those parameters.

11. The computer networked compensation survey method of claim 1, wherein the employment category is selected from a minimum and a maximum number of evaluation points and the comparison is limited to the companies that are within those parameters.

12. The computer networked compensation survey method of claim 1, wherein the data of a company making an inquiry is removable from the market data.

13. The computer networked compensation survey method of claim 1, wherein the recommended merit increase is based on the group consisting of a general rate of market increase, a performance level, a salary, and combinations thereof.

14. The computer networked compensation survey method of claim 13, wherein the general rate of market increase is based on what the company believes will be its merit increase budget.

15. The computer networked compensation survey method of claim 13, further wherein the level of performance is selected from the group consisting of outstanding, very good, satisfactory, sometimes acceptable, and poor.

16. The computer networked compensation survey method of claim 13, further wherein the general distribution of salaries in the company is selected from the group consisting of: positive distribution, normal distribution, and negative distribution.

17. The computer networked compensation survey method of claim 1, wherein the step of displaying the market data further comprises displaying the data of the company that is using the system, displaying the market averages, displaying the number of participants that provided data for the particular element, and displaying the proportion of company ratios with respect to the market averages.

18. The computer networked compensation survey method of claim 17, further wherein the step of displaying the number of participants that provided data for the particular element further includes displaying the number of incumbents affected by that element.

19. The computer networked compensation survey method of claim 1, wherein the graphical display is selected from the group consisting of: benefit analyses, monthly salary quartile graphs, total annual remuneration quartile graphs, company versus market (graphical), and company versus market (tabular).

20. The computer networked compensation survey method of claim 19, further wherein the graphical display of company versus market (graphical) displays two linear regression lines, one for the company and one for the market.

21. The computer networked compensation survey method of claim 19, further wherein the graphical display of company versus market (tabular) displays two regression tables, one for the company and one for the market.

22. A computer networked compensation survey method comprising:
selecting a market against which to be compared;
selecting an employment category to be researched;
providing market data for the job selected;
displaying the market data;
allowing a user to perform interpolation or extrapolation based on at least one employment category; and
simultaneously displaying more than one set of data.

23. The computer networked compensation survey method of claim 22 further comprising enabling the user to project to a future date.

24. The computer networked compensation survey method of claim 22 further comprising providing recommendations about merit increases.

25. The computer networked compensation survey method of claim 22 further comprising enabling the user to view market data graphically.

26. The computer networked compensation survey method of claim 22, wherein performing interpolation/extrapolation involves selecting from the group consisting of sales, number of employees, evaluation points, and combinations thereof.

27. The computer networked compensation survey method of claim 22, wherein the market to be compared is selected from the group comprising: services, manufacturing, pharmaceutical, free zone, commercial, insurance, banking, and others that may appear, including classification of industries by geographical locations, and combinations thereof.

28. The computer networked compensation survey method of claim 22, wherein the market to be compared comprises a select group of companies with which to be compared.

29. The computer networked compensation survey method of claim 22, wherein the market to be compared is capable of being further narrowed to the group consisting of sales range, number of employees, evaluation points, and combinations thereof.

30. The computer networked compensation survey method of claim 22, wherein the market to be compared is capable of being further narrowed to evaluation points.

31. The computer networked compensation survey method of claim 22, wherein the employment category is selected from a minimum and a maximum number of sales and the comparison is limited to the companies that are within those parameters.

32. The computer networked compensation survey method of claim 22, wherein the employment category is selected from a minimum and a maximum number of employees and the comparison is limited to the companies that are within those parameters.

33. The computer networked compensation survey method of claim 22, wherein the employment category is selected from a minimum and a maximum number of evaluation points and the comparison is limited to the companies that are within those parameters.

34. The computer networked compensation survey method of claim 22, wherein the data of a company making an inquiry is capable of being removed from the market data.

35. A computer networked compensation survey method comprising:
selecting a market against which to be compared;
selecting an employment category to be researched;
providing market data for the job selected;
displaying the market data; and
enabling the user to project to a future date.

36. The computer networked compensation survey method of claim 35 further comprising enabling a user to perform interpolation or extrapolation based on at least one employment category.

37. The computer networked compensation survey method of claim 35 further comprising providing recommendations about merit increases.

38. The computer networked compensation survey method of claim 35 further comprising enabling the user to view market data graphically.

39. The computer networked compensation survey method of claim 35, wherein the market to be compared is selected from the group consisting of services, manufacturing, pharmaceutical, free zone, commercial, insurance, banking, and others that may appear, including classification of industries by geographical locations, and combinations thereof.

40. The computer networked compensation survey method of claim 35, wherein the market to be compared comprises a select group of companies with which to be compared.

41. The computer networked compensation survey method of claim 35, wherein the market to be compared is capable of being further narrowed to the group consisting of sales range, number of employees, evaluation points, and combinations thereof.

42. The computer networked compensation survey method of claim 35, wherein the market to be compared is capable of being further narrowed to evaluation points.

43. The computer networked compensation survey method of claim 35, wherein the employment category is selected from a minimum and a maximum number of sales and the comparison is limited to the companies that are within those parameters.

44. The computer networked compensation survey method of claim 35, wherein the employment category is selected from a minimum number and a maximum number of employees, and the comparison is limited to the companies that are within those parameters.

45. The computer networked compensation survey method of claim 35, wherein the employment category is selected from a minimum and a maximum number of evaluation points and the comparison is limited to the companies that are within those parameters.

46. The computer networked compensation survey method of claim 35, wherein the data of a company making an inquiry is capable of being removed from the market data.

47. A computer networked compensation survey method comprising:
selecting a market against which to be compared;
selecting an employment category to be researched;
providing market data for the job selected;
displaying the market data; and
providing recommendations about merit increases.

48. The computer networked compensation survey method of claim 47 further comprising enabling the user to project to a future date.

49. The computer networked compensation survey method of claim 47 further comprising allowing a user to perform interpolation or extrapolation based on at least one employment category.

50. The computer networked compensation survey method of claim 47 further comprising enabling the user to view market data graphically.

51. The computer networked compensation survey method of claim 47, wherein the market to be compared is selected from the group consisting of services, manufacturing, pharmaceutical, free zone, commercial, insurance, banking, and others that may appear, including classification of industries by geographical locations, and combinations thereof.

52. The computer networked compensation survey method of claim 47, wherein the market to be compared comprises a select group of companies with which to be compared.

53. The computer networked compensation survey method of claim 47, wherein the market to be compared is capable of being further narrowed to the group consisting of sales range, number of employees, evaluation points, and combinations thereof.

54. The computer networked compensation survey method of claim 47, wherein the market to be compared is capable of being further narrowed to evaluation points.

55. The computer networked compensation survey method of claim 47, wherein the employment category is selected from a minimum and a maximum number of sales and the comparison is limited to the companies that are within those parameters.

56. The computer networked compensation survey method of claim 47, wherein the employment category is selected from a minimum and a maximum number of employees and the comparison is limited to the companies that are within those parameters.

57. The computer networked compensation survey method of claim 47, wherein the employment category is selected from a minimum and a maximum number of evaluation points and the comparison is limited to the companies that are within those parameters.

58. The computer networked compensation survey method of claim 47, wherein the data of a company making an inquiry is capable of being removed from the market data.

59. The computer networked compensation survey method of claim 47, wherein the recommended merit increase is based on the group consisting of a general rate of market increase, a performance level, a salary, and combinations thereof.

60. The computer networked compensation survey method of claim 59, further wherein the general rate of market increase is based on what the company believes will be its merit increase budget.

61. The computer networked compensation survey method of claim 59, further wherein the level of performance is selected from the group consisting of: outstanding, very good, satisfactory, sometimes acceptable and poor.

62. The computer networked compensation survey method of claim 59, further wherein the general distribution of salaries in the company is selected from the group consisting of: positive distribution, normal distribution, and negative distribution.

63. A computer networked compensation survey method comprising:
selecting a market against which to be compared;
selecting an employment category to be researched;
providing market data for the job selected;
displaying the market data; and
enabling the user to view market data graphically.

64. The computer networked compensation survey method of claim 63 further comprising enabling the user to project to a future date.

65. The computer networked compensation survey method of claim 63 further comprising providing recommendations about merit increases.

66. The computer networked compensation survey method of claim 63 further comprising allowing a user to perform interpolation or extrapolation based on at least one employment category.

67. The computer networked compensation survey method of claim 63, wherein the market to be compared is capable of being selected from the group consisting of services, manufacturing, pharmaceutical, free zone, commercial, insurance, banking, and others that may appear, including classification of industries by geographical locations, and combinations thereof.

68. The computer networked compensation survey method of claim 63, wherein the market to be compared comprises a select group of companies with which to be compared.

69. The computer networked compensation survey method of claim 63, wherein the market to be compared is capable of being further narrowed to the group comprising sales range, number of employees, evaluation points, and combinations thereof.

70. The computer networked compensation survey method of claim 63, wherein the employment category is selected from a minimum and a maximum number of sales and the comparison is limited to the companies that are within those parameters.

71. The computer networked compensation survey method of claim 63, wherein the employment category is selected from a minimum and a maximum number of employees and the comparison is limited to the companies that are within those parameters.

72. The computer networked compensation survey method of claim 63, wherein the employment category is selected from a minimum and a maximum number of evaluation points and the comparison is limited to the companies that are within those parameters.

73. The computer networked compensation survey method of claim 63, wherein the data of a company making an inquiry is capable of being removed from the market data.

74. The computer networked compensation survey method of claim 63, wherein the step of displaying the market data further comprises displaying the data of the company that is using the system, displaying the market averages, displaying the number of participants that provided data for the particular element, and displaying the proportion of company ratios with respect to the market averages.

75. The computer networked compensation survey method of claim 63, wherein the graphical display is selected from the group consisting of benefit analyses, monthly salary quartile graphs, total annual remuneration quartile graphs, company versus market (graphical), company versus market (tabular), and combinations thereof.

76. The computer networked compensation survey method of claim 75, further wherein the graphical display of company versus market (graphical) displays two linear regression lines, one for the company and one for the market.

77. The computer networked compensation survey method of claim 75, further wherein the graphical display of company versus market (tabular) displays two regression tables, one for the company and one for the market.
